(19) United States
(12) Patent Application Publication
(10) Pub. No.: US 2014/0269345 A1
(43) Pub. Date: Sep. 18, 2014

(54) METHOD AND SYSTEM FOR NETWORK TROUBLESHOOTING AND IMPROVING KPI OF MOBILE DATA NETWORK

(71) Applicant: Nishi Kant, Fremont, CA (US)

(72) Inventor: Nishi Kant, Fremont, CA (US)

(73) Assignee: Connectem Inc., San Jose, CA (US)

(21) Appl. No.: 14/214,693

(22) Filed: Mar. 15, 2014

Related U.S. Application Data
(60) Provisional application No. 61/802,508, filed on Mar. 16, 2013.

(51) Int. Cl. H04W 24/08

(52) U.S. Cl. CPC H04W 24/08
USPC 370/242; 370/241

(57) ABSTRACT

A mechanism to allow operators to automatically populate a knowledgebase with protocol characteristics of each mobile device type. In case a mobile device fails to complete signaling dialogue, it logs the messages exchanged till the point the failure occurred. On such failure it triggers a notification so that network operator is alerted with the fact that new device type is failing to get access to the network due to protocol error. Such notification can be used to debug the issue and correct the problem or update customer care information base so that when the affected customer calls, a Customer Service Representative has adequate information to explain to the customer.

### CROSS-REFERENCE TO RELATED PATENT APPLICATIONS

The present invention claims priority from U.S. Provisional Patent Application Ser. No. 61/802,508, filed Mar. 16, 2013, the disclosure of which is herein specifically incorporated by reference in its entirety.

### FIELD OF THE INVENTION

The present invention relates generally to mobile wireless networks which includes general packet radio service (GPRS) networks, Universal Mobile Telecommunications Systems (UMTS) and Long Term Evolution (LTE) systems. Standardization work has also been done to interwork Wi-Fi radio with above-said networks. Specifically, this disclosure relates to a method and system for allowing operators to automatically populate a knowledge base with protocol characteristics of each device type which will help troubleshoot the issues in their network.

### BACKGROUND

Mobile broadband data networks are becoming pervasive in modern day life. Not long ago, there were only a handful of mobile device manufacturers and the mobile network was accessible to such devices for a small set of use cases such as mobile voice or narrowband data. Today the broadband mobile network is used by a wide variety of devices (smartphone, tablets, data modem, ebook readers, cars, smart meters, etc.) for general or special purpose communication. Low cost or free mobile operating systems such as Android®, Firefox®, etc. have made it possible for devices to have broadband connectivity. The mobile broadband network includes licensed Third Generation (3G)/Fourth Generation (4G) networks and hybrid networks combining Wi-Fi access with 3G/4G networks. In recent times, the popularity of Android® has added more devices types than ever before. Device to network interaction depends on standardized protocols, however the interpretation of such protocols may vary across various manufacturers.

While mobile operators strive hard to make sure that the devices they sell work well, it should be clear from the preceding paragraph that device from other sources will show up in a network. Users can buy devices from foreign sources, device manufacturers or other operators and get them unlocked. Irrespective of the source, the users will expect it to work. If it does not the users are likely to blame the network. This will affect customer satisfaction.

### SUMMARY

An aspect of the present disclosure is a method of optimizing operation of a packet network comprising: requesting an IMEI from a mobile device as part of an attach procedure; determining from the IMEI if the mobile device is a new type of mobile device; and if so, capturing all messages into a knowledgebase related to activities of the mobile device until the mobile device detaches.

Another aspect of the present disclosure is a network element of a packet network comprising: a network interface unit configured to interact with the packet network; and a processor with a memory associated with the network interface unit and adapted to: request an IMEI from a mobile device as part of an attach procedure; determine from the IMEI if the mobile device is a new type of mobile device; and if so, capture all messages into a knowledgebase related to activities of the mobile device until the mobile device detaches.

### BRIEF DESCRIPTION OF THE DRAWINGS

The present invention is illustrated by way of example and not limitation in the figures of the accompanying drawings in which like references indicate similar elements.

FIG. 1 is a block diagram illustrating mobile communications over a typical Third Generation Partnership Project (3GPP) packet core network and the interconnection with Radio Access Networks (RANs) and external networks (e.g, Internet or enterprise network).

FIG. 2 illustrates equipment identity known as International Mobile Equipment Identifier (IMEI)/International Mobile Equipment Identifier Software Version (IMEISV) for mobile devices.

FIG. 3 is a call flow diagram that shows inclusion of IMEI in a security dialog.

FIG. 4 is a block diagram of an embodiment(s) of the network element described herein.

### DETAILED DESCRIPTION

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

FIG. 1 shows 3GPP networks (3G UMTS and 4G LTE) connecting mobile devices to the Internet as well as a private data network. It also shows interworking with Wi-Fi access. Mobile devices 102 and 103 are communicatively coupled to a packet core network 110. For example, 3G/4G User Equipment (UE) 102 is coupled to packet core network 110 via a 3G RAN 104 through, for example, node B (NB) and radio network controller (RNC) 105 and from there to the packet core node through the Serving GPRS Support Node (SGSN) 111. The UE 102 is additionally coupled to the core network 110 via a corresponding LTE access network (e.g., evolved UMTS terrestrial RAN (Evolved Universal Terrestrial Radio Access Network (E-UTRAN)) node B (eNB) 106. Finally the 3G/4G/Wi-Fi UE 103 is coupled to the packet core network 110 via RNC 105 or eNB 106 or via Wi-Fi access point 123. In order to communicate to a data service located in other networks such as the Internet 120 and/or private network enterprise (or enterprise premise) 121, UE data devices 102 and 103 have to go through packet core network 110. Typically, packet core network 110 includes SGSN 111 for the 3G network or Mobility Management Entity (MME) 113a/serving gateway (S-GW) 113c for the LTE network 106 and a gateway GPRS support node (GGSN) 112 for the 3G network or packet data network (PDN-GW) 114 for the LTE network. The packet core network 110 also has evolved packet date gateway (ePDG) 122 and 3GPP AAA Server 113b when Wi-Fi access 123 is interworked. SGSN 111/S-GW 113c and GGSN 112/PDN-GW 114 relay communications between UE 102 and UE 103 and a destination (e.g. Internet 120 and enterprise server 121). A typical packet core network 110 also includes a home location register (HLR) or home subscriber server (HSS) 117 storing subscription profile and a policy and charging rule function (PCRF) 118.

The method and system disclosed herein illustrate automatically populating a knowledge database (knowledgebase) with a plurality of protocol characteristics of each mobile device type. In case a mobile device fails to complete a signaling dialogue, a network element logs the messages exchanged till the point the failure occurred. On such failure the network element triggers a notification so that a network operator is alerted with the fact that a new mobile device type is failing to get access to the network due to protocol error. The network operator can use such notifications to debug the issue and correct the problem or update its customer care information base so that when the affected customer calls, the customer service representative has adequate information to explain to the customer. Details of the method and system of implementing these functions are disclosed below.

As shown in FIG. 2, each mobile device 102,103 has an equipment identity known as IMEI/IMEISV 200. The IMEI 200 is encoded as AA-BBBBBB-CCCCCC-EE. The first eight digits identify Type Allocation Code (TAC) 202. The first two digits of the TAC (i.e., AA) are the Reporting Body Identifier (RBI), which identifies the GSMA-approved group that allocated the TAC. The next six digits BBBBBB identify the manufacturer and model. The next six digits CCCCCC are the serial number (SNR) 204 of the device. Finally, the last two digits EE identify the software version (SVN or SV) 206.

Thus, the IMEI=01-334700-060021-03 can be decoded to obtain the following information.
IMEI number: 013347000600210
IMEI checksum: Check digit NOT presented with IMEISV
Type Allocation Code (TAC): 01334700
Serial number: 060021
IMEISV 0133470006002103
Software Version (SV): 03
Issuer: CTIA

The TAC of 01/334700 identifies CTIA as the RBI and 334700 as Apple iPhone5. The device information is as follows.
Brand: APPLE
Model: IPHONE 5
Manufacturer: APPLE
Device type: PHONE
Additional info: A1429

Such IMEI based data can then be augmented with device specifications as follows.
GPS: YES, WITH A-GPS SUPPORT AND GLONASS
Browser: HTML (SAFARI)
Operating system: IOS 6
Camera: 8 MP, 3264×2448 PIXELS, AUTOFOCUS, LED FLASH
Bluetooth: YES, V4.0 WITH A2DP
WLAN: WI-FI 802.11 A/B/G/N, DUAL-BAND, WI-FI PLUS CELLULAR
EDGE: YES
GPRS: YES
Internal memory: 16/32/64 GB STORAGE, 1 GB RAM
Memory card slot: NO
DISPLAY|MULTITOUCH: YES
Display size: 640×113a6 PIXELS, 4.0 INCHES (˜326 PPI PIXEL DENSITY)
Display type: LED-BACKLIT IPS TFT, CAPACITIVE TOUCHSCREEN, 16M COLORS

Similarly by decoding IMEI=86-378101-012504-00, one can obtain the following information.
IMEI ANALYSIS
IMEI number: 863781010125040
IMEI checksum: Check digit NOT presented with IMEISV
Type Allocation Code (TAC): 86378101
Serial number: 012504
IMEISV 8637810101250400
Software Version (SV): 00
Issuer: TAF China (Telecommunication Terminal Testing & Approval Forum)

### DEVICE INFO

Brand: HUAWEI
Model: E3276S-150
Manufacturer: HUAWEI TECHNOLOGIES CO LTD
Additional info: E3276S

From the above it should be clear that information contained in an IMEI 200 can be effectively used to monitor the kinds of mobile devices present in the network 110. IMEI 200 is not required to be present in device to network signaling by default. Asking for IMEI through explicit messages add one round trip of latency. Therefore in Release 8, 3GPP allows IMEI to be implicitly included in the security mode procedure with less overhead.

As disclosed in the method and system herein, the packet network 110 requests the IMEISV from the mobile device (e.g., 102) (preferably as part of the security mode procedure) and looks up the TAC in a knowledge database (DB) located at a network element in the packet network 110. (The network element structure is discussed in detail in the description of FIG. 4). If the TAC is new (or not recognized by the DB), the network element instructs its logger function to store complete octet stream of all messages sent and received during this session in the DB. Further, the network element ties the IMEISV to the IMSI or Globally Unique Temporary ID (GUTI) of the user and turns on a flag for the capture of all messages related to other activities of the user (session management, mobility management, etc.) till the mobile device detaches. Upon detach, the flag is turned off.

If another device with the same TAC interacts with the network, the network does not turn on the capture flag in normal cases. However, whenever the network encounters a protocol error (incorrect message, information element, timeout, etc.), it sends explicit request to obtain the IMEISV. The network element then instructs its logger function to store the messages leading to the error in the database entry for the associated TAC for the complete failed transaction. Also, as per the embodiments disclosed herein, the network element could create an alert so that a network operator can look at failure proactively.

FIG. 3 is a call flow diagram 300 that shows inclusion of IMEI 200 in a security dialog between user equipment (or mobile device) 102 and MME 113a. In step 306, UE 102 sends an attach request. If UE 102 had successfully attached with this network in the past and has valid security context from that interaction, the UE 102 will integrity protect this message using that security context. If the MME 113a is able to recognize the UE identity, the protocol capture as per this disclosure is stopped. This is because if the UE 102 is known in the system, its protocol signature should have been obtained in a previous attach. Otherwise the entire received message and the response from the MME 113a is buffered for storage in a protocol signature (or knowledge) database. In step 308, if UE 102 is not known in the system, the MME 113a requests the UE 102 identity. In step 310, UE 102 responds with its identity IMSI. In step 312, since the UE 102 was unknown and no security context existed for this UE 102 in the MME 113a, the MME 113a starts a security procedure. In step 314, as part of security procedure, the MME 113a obtains the IMEI of the device. The MME 113a inspects the TAO and SV of the IMEI. If this TAC+SV exists in the protocol signature database, the protocol capture is stopped. Otherwise MME 113a continues to buffer received messages and responses for the storage in the protocol signature database. In step 316 the ciphered options request is made by the MME 113a and in step 318 the UE 102 provides the ciphered option response. In step 320, the MME 113a sends attach accept to the UE 102. The protocol capture for this device type continues for all signaling that happens till the device detaches at some point as shown in step 322. In step 324, the MME 113a sends the detach accept and marks protocol capture complete and stores it in the protocol signature database for the TAC+SV type.

The network element 400 as described above and further illustrated in FIG. 4 preferably is located in the core network (including being integrated with an MME) or the functions as described herein may be divided among a plurality of network elements in the core network 110. However, in other embodiments the network element is not located physically at the core network 110 but is logically located between the core network and the eNBs. The network element may have a controller, logic, memory, interface, and input/output which may be implemented using any suitable hardware, software and/or firmware configured as shown in FIG. 4. FIG. 4 comprises one or more system control logic 404 coupled with at least one or all of the processor(s) 402, system memory 406, a network interface 408 (including a transceiver 408a), and input/output (I/O) devices 410. The processor(s) 402 may include one or more single-core or multi-core processors. The processor(s) 402 may include any combination of general-purpose processors and dedicated processors (e.g., graphics processors, application processors, baseband processors, etc.). System control logic 404 for one embodiment may include any suitable interface controllers to provide for any suitable interface to at least one of the processor(s) 402 and/or to any suitable device or component in the packet core network 110 in communication with system control logic 404. System control logic 404 for one embodiment may include one or more memory controller(s) to provide an interface to system memory 406. System memory 406 may be used to load and store data and/or instructions such as the knowledge database and logger function discussed above. System memory 406 for one embodiment may include any suitable volatile memory, such as suitable dynamic random access memory (DRAM), for example. System memory 406 may also include non-volatile memory including one or more tangible, non-transitory computer-readable media used to store data and/or instructions, for example, such as the embodiments described herein. The non-volatile memory may include flash memory, for example, and/or may include any suitable non-volatile storage device(s), such as one or more hard disk drive(s) (HDD(s)), one or more compact disk (CD) drive(s), and/or one or more digital versatile disk (DVD) drive(s). The memory 406 may include a storage resource physically part of a device. For example, the memory 404 may be accessed over a network via the network interface 408 and/or over Input/Output (I/O) devices 410. Network interface 408 may have a transceiver 408a to provide a radio interface to communicate over one or more network(s) and/or with any other suitable device. Network interface 408 may include any suitable hardware and/or firmware. The network interface 408 may include a plurality of antennas to provide a multiple input, multiple output radio interface. Network interface 408 for one embodiment may include, for example, a wired network adapter, a wireless network adapter, a telephone modem, and/or a wireless modem. For one embodiment, at least one of the processor(s) 402 may be packaged together with logic for one or more controller(s) of system control logic 404. For one embodiment, at least one of the processor(s) 402 may be integrated on the same die with logic for one or more controller(s) of system control logic 404. In various embodiments, the I/O devices 410 may include user interfaces designed to enable user interaction with peripheral component interfaces designed to enable peripheral component interaction and/or sensors designed to determine environmental conditions and/or location information related to the network element or system. In various embodiments, the peripheral component interfaces may include, but are not limited to, a non-volatile memory port, a universal serial bus (USB) port, an audio jack, and a power supply interface.

Alternatively, some embodiments and methods discussed above may be implemented by a non-transitory computer-readable medium storing a program for performing the process. The computer readable medium may store (in any appropriate format) those program elements which are appropriate to perform the method. The term “non-transitory computer readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media may include, for example, optical or magnetic disks and other persistent memory. Volatile media may include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, a Random Access Memory (RAM), a programmable read only memory (PROM), an erasable programmable read only memory (EPROM), a flash electrically erasable programmable read only memory (FLASH-EEPROM), any other memory chip or cartridge, a carrier wave as described hereinafter, or any other medium from which a computer can read.

In an embodiment, a server computer, network element or centralized authority may not be necessary or desirable. For example, an embodiment may be practiced on one or more devices without a central authority. In such an embodiment, any functions described herein as performed by the server computer or data described as stored on the server computer may instead be performed by or stored on one or more such devices.

Although process (or method) steps may be described or claimed in a particular sequential order, such processes may be configured to work in different orders. In other words, any sequence or order of steps that may be explicitly described or claimed does not necessarily indicate a requirement that the steps be performed in that order unless specifically indicated. Further, some steps may be performed simultaneously despite being described or implied as occurring non-simultaneously (e.g., because one step is described after the other step) unless specifically indicated. Moreover, the illustration of a process by its depiction in a drawing does not imply that the illustrated process is exclusive of other variations and modifications thereto, does not necessarily imply that the illustrated process or any of its steps are necessary to the embodiment(s), and does not imply that the illustrated process is preferred.

In this disclosure, devices or networked elements that are described as in “communication” with each other or “coupled” to each other need not be in continuous communication with each other or in direct physical contact, unless expressly specified otherwise.

In the foregoing specification, embodiments have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

1. A method of optimizing operation of a packet network comprising:
requesting an IMEI from a mobile device as part of an attach procedure;
determining from the IMEI if the mobile device is a new type of mobile device; and
if so, capturing all messages in a knowledgebase related to activities of the mobile device until the mobile device detaches.

2. The method of claim 1, wherein a security mode procedure is part of the attach procedure.

3. The method of claim 1, wherein the Type Allocation Code (TAC) of the IMEI is used to determine if the mobile device is a new type of mobile device.

4. The method of claim 3, wherein the Software Version (SV) of the IMEI is also used to determine if the mobile device is a new type of mobile device

5. The method of claim 1, further comprising:
populating the knowledgebase with protocol characteristics of the new type of mobile device.

6. The method of claim 1, further comprising:
if the mobile device fails to complete a signaling dialogue, logging messages exchanged between the mobile device and the packet network until the point the failure occurred.

7. The method of claim 6, further comprising:
notifying a network operator when the mobile device is failing to obtain access to the packet network due to protocol error.

8. The method of claim 1, further comprising:
if the mobile device completes a signaling dialogue, logging messages exchanged until a moment the mobile device detaches.

9. The method of claim 1 further comprising:
if the mobile device is not a new type of mobile device and if a protocol error is detected;
request the IMEI again from the mobile device;
store the messages leading to the protocol error in the database associated with the IMEI of the mobile device; and
send an alert to a network operator.

10. A network element of a packet network comprising:
a network interface unit configured to interact with the packet network; and
a processor with a memory associated with the network interface unit and adapted to:
request an IMEI from a mobile device as part of an attach procedure;
determine from the IMEI if the mobile device is a new type of mobile device; and
if so, capture all messages in a knowledgebase related to activities of the mobile device until the mobile device detaches.

11. The network element of claim 10, wherein a security mode procedure is part of the attach procedure.

12. The network element of claim 10, wherein the Type Allocation Code (TAC) of the IMEI is used to determine if the mobile device is a new type of mobile device.

13. The network element of claim 12, wherein the Software Version (SV) of the IMEI is also used to determine if the mobile device is a new type of mobile device.

14. The network element of claim 10, wherein the processor is further adapted to:
populate the knowledgebase with protocol characteristics of the new type of mobile device.

15. The network element of claim 10, wherein the processor is further adapted to:
detect if the mobile device fails to complete a signaling dialogue, and
log the messages exchanged between the mobile device and the packet network until the point the failure occurred.

16. The network element of claim 15, wherein the processor is further adapted to:
notify a network operator when the mobile device is failing to obtain access to the packet network due to protocol error.

17. The network element of claim of claim 10,
if the mobile device completes a signaling dialogue, logging messages exchanged until a moment the mobile device detaches

18. The network element of claim 10, wherein the processor is further adapted to:
detect if the mobile device is not a new type of mobile device and if a protocol error is detected;
request the IMEI from the mobile device;
store the messages leading to the protocol error in the database associated with the IMEI of the mobile device; and
send an alert to a network operator.

19. A non-transitory computer readable medium containing program instructions for optimizing performance of a packet network, wherein execution of the program instructions by one or more processors of a computer system causes the one or more processors to carry out the steps of:
requesting an IMEI from a mobile device as part of an attach procedure;
determining from the IMEI if the mobile device is a new type of mobile device; and
if so, capturing all messages in a knowledgebase related to activities of the mobile device until the mobile device detaches.

20. The non-transitory computer readable medium of claim 19, further causing the one or more processors to carry out the steps of:
if the mobile device fails to complete a signaling dialogue, logging the messages exchanged between the mobile device and the packet network until the point the failure occurred; and
notifying a network operator when the mobile device is failing to get access to the packet network due to protocol error.
